(19) United States
(12) Patent Application Publication
(10) Pub. No.: US 2009/0196953 A1
(43) Pub. Date: Aug. 6, 2009

(54) Kimchi container having improved fermentation and ripening function, and kimchi ripening method using the same

(75) Inventor: Sin-Ja Sin, Chungbuk (KR)

Correspondence Address: HOLLAND & HART, LLP, P.O BOX 8749, DENVER, CO, 80201, US

(73) Assignee: Jang Chung Dong Wang Jok Bal Co., Ltd., Daejeon (KR)

(21) Appl. No.: 12/075,771

(22) Filed: Mar. 13, 2008

(30) Foreign Application Priority Data
Feb. 4, 2008 (KR) 10-2008-0011246

(51) Int. Cl. A23B 7/10; A23L 3/00; A23B 7/158

(52) U.S. Cl. 426/49; 99/467; 99/470

(57) ABSTRACT

Disclosed are a kimchi container with an improved fermentation and ripening function and a kimchi ripening method. The container includes a body and holding unit. The body accommodates kimchi, and includes locking protrusions normally projected from four sides of an inner wall and an opened side to be vacuum-sealed after accommodation of the kimchi. The holding unit includes a contact part having a cross-sectional area corresponding to that of the inner bottom of the body, and through-holes formed in the circumference and at a central region of the upper side. The holding unit further includes locking grooves, to be fitted onto corresponding locking protrusions of the body, formed at an outer wall upwardly extended from and integrally formed with the rim of the contact part. Thereby, tilting of the kimchi container causes the kimchi juice to circulate freely through the holding unit and to return to the kimchi.

### BACKGROUND OF THE INVENTION

1. Field of the Invention

The present invention relates to a kimchi container having an improved and ripening function and, more particularly, to a kimchi container having an improved fermentation and ripening function in which during fermentation and ripening a pressing function forces kimchi juice to circulate and to sufficiently permeate through packaged kimchi to prevent a portion of the kimchi that is not soaked in the kimchi juice from being dry, so that the kimchi can be kept in a form existing at the time of packing and can be delivered in an optimally fermented and ripened state, and to a kimchi ripening method using the same.

2. Description of the Related Art

Kimchi is made of Korean cabbages and radishes that are mixed with spices including hot pepper, garlic, ginger and salted fish and then allowed to undergo lactic acid fermentation at a low temperature. For a long time, kimchi has been a valuable source of vitamins, fibers and minerals to Koreans in the winter at which time fresh vegetables are scarce. Recent studies have shown that Korean kimchi is a fermented food good for intestinal regulation using lactic acid bacteria.

Currently, 330 or more kimchis are known to exist. According to main ingredients, preparation schemes, storage schemes and fermentation schemes, kimchis may be classified into the following groups: ‘regular kimchi’ (173 items), ‘cubed radish kimchi’ (20 items), ‘watery radish kimchi’ (7 items), ‘vegetable salted not long before eating’ (19 items), ‘uncooked vegetable’ (26 items), ‘sliced radish or cucumber dried and seasoned with soy’ (75 items), ‘radish preserved with salt’ (3 items), and ‘pickle’ (2 items).

Kimchi has various nutrients such as vitamin B complex, beta-carotene, and vitamin C in great quantities; and vitamin B complex and vitamin C are contained in ingredients of kimchi, and are biosynthesized further during fermentation. Beta-carotene is contained in ingredients such as carrots, powdered red pepper, and green onions which act as nutrient sources providing significant amounts of minerals, dietary fibers, and amino acids.

For storage and management, traditionally, kimchi has been put in a kimchi jar buried in the ground and allowed to undergo fermentation and ripening. These days, kimchi is put in a specially designed kimchi storage unit installed at a dining room or cafeteria. For good taste, it is necessary to prevent stored kimchi from contact with the ambient air. That is, kimchi in a kimchi jar is pressed by a stone weight so as not to float on the kimchi juice, or is packed with salted cabbage leaves. Consequently, the stored kimchi is soaked in the kimchi juice and is isolated from the ambient air, resulting in retarded oxidation and high dissolution of carbon dioxide (CO₂).

Traditionally, kimchi has been prepared at home, put in a kimchi jar for storage, and consumed as a homemade side dish. These days, with rapid growth of the kimchi industry, kimchi has been prepared commercially on a large scale, packaged in various types of containers, and distributed as commercial products. In general, commercial kimchi is packed and distributed for home use or group meals. Small kimchi products are packaged in units of 100-500 grams using glass bottles, plastic containers, aluminum foil films, and plastic films. Large kimchi products are packaged in units of at least 5 kilograms using corrugated cardboards, plastic containers, metallic containers, and plastic films.

For packaged distribution, the opened side of a kimchi container accommodating kimchi is vacuum-sealed with a sheet to prevent leakage of the kimchi juice during shipment. In the case of a side dish having a small amount of spicy juice, the side dish in a storage container may change in shape owing to shaking of the container during shipment, but does not significantly change in taste itself. However, in the case of a kimchi, such as a side dish having a large amount of spicy juice, contained in a storage container in a vacuum-sealed state, repealed tilting of the container to one side during long-distance shipment causes deformation in shape of the kimchi.

In addition, if the kimchi juice is concentrated to one side within the container, the portion of the kimchi submerged under the kimchi juice experiences an insignificant change in taste and moderately ripens. However, the portion of the kimchi exposed from the kimchi juice experiences degradation of taste and becomes dry because of extraction of kimchi juice.

### SUMMARY OF THE INVENTION

Therefore, the present invention has been made in view of the above problems, and it is an object of the present invention to provide a kimchi container having an improved fermentation and ripening function and a kimchi ripening method using the same, wherein a pressing function of the container prevents free movement of accommodated kimchi within the container and forces kimchi juice to sufficiently permeate and circulate through the kimchi to prevent a portion of the kimchi that is not soaked in the kimchi juice from being dry during fermentation and ripening, so that the kimchi can be kept in a form existing at the time of packing and can be delivered in an optimally fermented and ripened state.

In accordance with an aspect of the present invention, there is provided a kimchi container with an improved fermentation and ripening function, including: a body to accommodate kimchi, including locking protrusions normally projected from four sides of an inner wall of the body and an opened side to be vacuum-sealed with a sheet after accommodation of the kimchi; and a holding unit including: a contact part having a cross-sectional area corresponding to that of the inner bottom of the body, and a plurality of through-holes formed in the circumference and at a central region of the upper side thereof; and a plurality of locking grooves, to be fitted onto corresponding locking protrusions of the body, formed at an outer wall upwardly extended from and integrally formed with the rim of the contact part, wherein the lower side of the contact part contacts with the kimchi accommodated in the body by fitting the locking grooves of the holding unit onto the corresponding locking protrusions of the body by stages, so that, when the kimchi container is tilted to one side during movement, the kimchi juice enters the holding unit through the through-holes of the contact part, and circulates freely within the holding unit, and returns to the kimchi through the througholes.

In accordance with another aspect of the present invention, there is provided a kimchi ripening method wherein kimchi accommodated in a kimchi container with an improved fermentation and ripening function is constantly submerged under the kimchi juice for a ripening period.

In a feature of the present invention, when kimchi is contained in a kimchi container of the present invention, the pressing function of the kimchi container forces the kimchi juice to permeate and circulate through the kimchi so that the kimchi is submerged constantly under the kimchi juice and prevented from dryness in part. During shipment, the kimchi is preserved in a form existing at the time of packing. During fermentation and ripening, oxidation of the kimchi is retarded, and carbon dioxide (CO₂) readily dissolves in the kimchi. Thus, the kimchi container enables delivery of fresh and tasty kimchi.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a kimchi container according to an embodiment of the present invention;

FIG. 2 is a side sectional view of the kimchi container of FIG. 1;

FIG. 3 is a perspective view of a holding unit according to another embodiment of the present invention;

FIG. 4 is a side sectional view of a kimchi container having the holding unit of FIG. 3;

FIG. 5 is a perspective view of a holding unit according to another embodiment of the present invention;

FIG. 6 is a front sectional view of a kimchi container having the holding unit of FIG. 5;

FIG. 7 is graphs illustrating measured pH values of a first experimental group and first control group with the passage of fermentation time;

FIG. 8 is graphs illustrating pH values of a second experimental group and second control group with the passage of fermentation time;

FIG. 9 is graphs illustrating acidity levels of the first experimental group and first control group with the passage of fermentation time;

FIG. 10 is graphs illustrating acidity levels of the second experimental group and second control group with the passage of fermentation time;

FIG. 11 is graphs illustrating CO₂ concentration levels of the first experimental group and first control group with the passage of fermentation time;

FIG. 12 is graphs illustrating CO₂ concentration levels of the second experimental group and second control group with the passage of fermentation time;

FIG. 13 is graphs illustrating the quantities of Leuconostoc sp. bacteria for the first experimental group and first control group with the passage of fermentation time;

FIG. 14 is graphs illustrating the quantities of Leuconostoc sp. bacteria for the second experimental group and second control group with the passage of fermentation time;

FIG. 15 is graphs illustrating the quantities of Lactobacillus sp. bacteria for the first experimental group and first control group with the passage of fermentation time; and

FIG. 16 is graphs illustrating the quantities of Lactobacillus sp. bacteria for the second experimental group and second control group with the passage of fermentation time.

### DETAILED DESCRIPTION OF THE PREFERRED EMBODIMENTS

Hereinafter, preferred embodiments of the present invention will be described in detail with reference to the accompanying drawings.

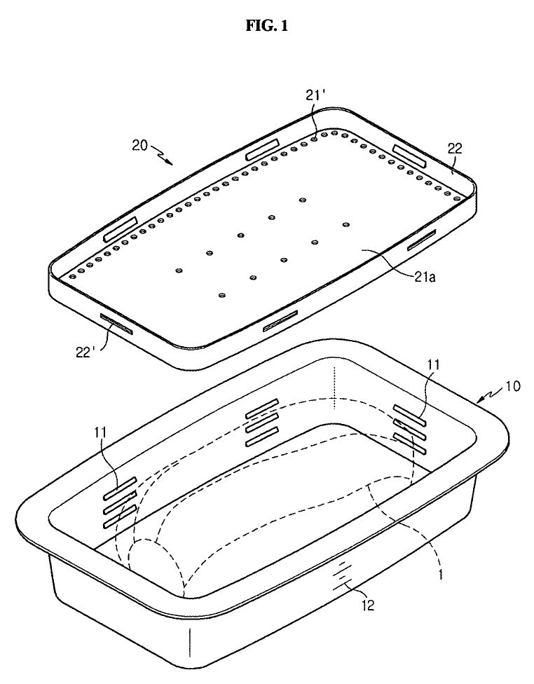

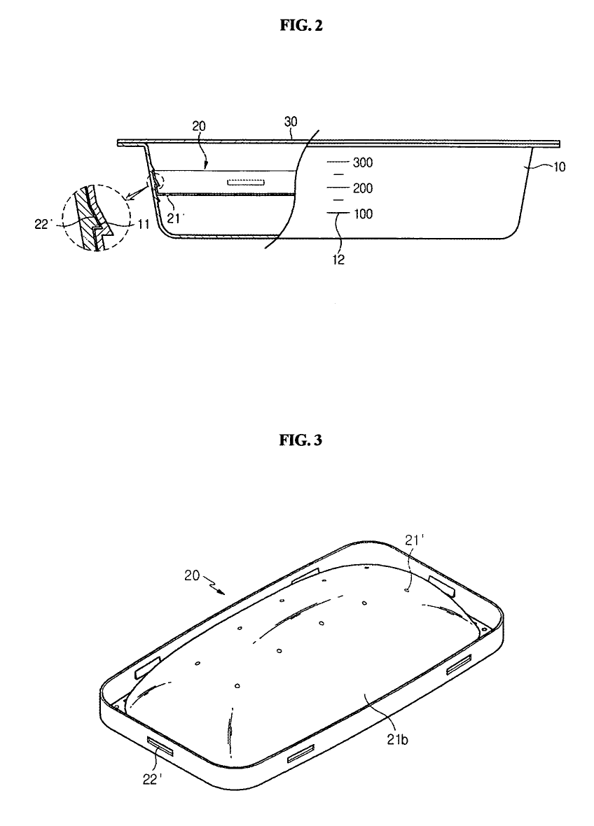

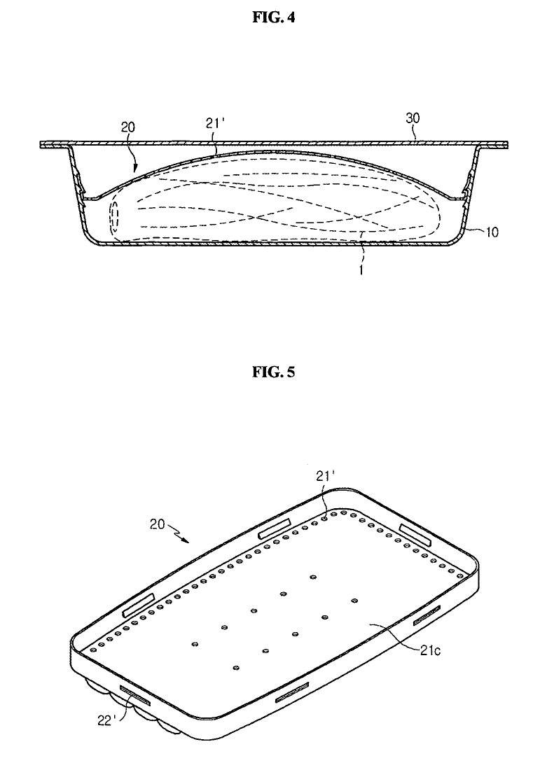

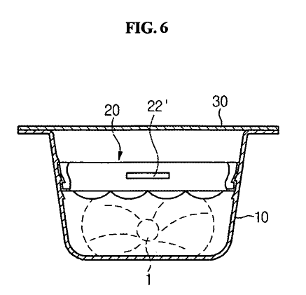

FIG. 1 is an exploded perspective view of a kimchi container according to an embodiment of the present invention, and FIG. 2 is a side sectional view of the kimchi container of FIG. 1. FIG. 3 is a perspective view of a holding unit, and FIG. 4 is a side sectional view of a kimchi container having the holding unit of FIG. 3. FIG. 5 is a perspective view of another holding unit, and FIG. 6 is a front sectional view of a kimchi container having the holding unit of FIG. 5. In the drawings, reference symbol ‘1’ indicates kimchi.

The kimchi container of the present invention includes a container body 10 to accommodate kimchi, and the opened side of the body 10 is vacuum-sealed with a sheet 30 after kimchi is accommodated therein. The body 10 includes locking protrusions 11 normally projected from four sides of the inner wall of the body 10. The kimchi container further includes a holding unit 20. The holding unit 20 includes a contact part 21a, which has a cross-sectional area corresponding to that of the inner bottom of the body 10, and a plurality of through-holes 21′ formed in the circumference and at the central region of the upper side of the contact part 21a The holding unit 20 further includes a plurality of locking grooves 22′, to be fitted onto corresponding locking protrusions 11 of the body 10, formed at an outer wall upwardly extended from and integrally formed with the rim of the contact part 21a. The holding unit 20 is installed by fitting the locking grooves 22′ onto the corresponding locking protrusions 11 of the body 10 by stages so that the lower side of the contact part 21a contacts with the kimchi 1 contained in the body 10. Thereby, when the kimchi container is tilted to one side during shipment, the kimchi juice can enter the holding unit 20 through the through-holes 21′ of the contact part 21a, circulate freely within the holding unit 20, and return to the kimchi 1 through the through-holes 21′.

In an embodiment, the holding unit 20 includes a dome-shaped contact part 21b suitable for accommodating whole-cabbage kimchi.

In another embodiment, the holding unit 20 includes a contact part 21c having a hemispheric pressing structure at the central part of the lower side thereof to prevent the kimchi from freely moving during shipment.

The holding unit 20 is made of transparent or translucent synthetic resin, and preferably has a thickness that does not cause the kimchi to be overly pressed.

Preferably, the holding unit 20 further includes an outwardly inclined support part 22 so that locking grooves 22′ of the support part 22 can be elastically coupled to corresponding locking protrusions 11 of the body 10.

Through-holes 21′ in the outer circumference of the contact part 21a are formed more densely than those formed at the central region so that kimchi juice can readily flow through the holding unit 20.

The body 10 further includes a scale indicator 12 at a side thereof and a user can easily check the amount of kimchi contained in the body 10.

Next, functions and features are described of the kimchi container for enhanced fermentation and ripening.

The kimchi container of the present invention is the same as a conventional kimchi container in that the opened side of the body 10 is vacuum-sealed with a sheet 30.

However, the kimchi container of the present invention includes a holding unit 20 easily installable in the body 10. The holding unit 20 limits free movement of the contained kimchi and acts as a stone weight, which forces kimchi juice to permeate and circulate through the kimchi in a manner sufficient to prevent dryness of a portion of the kimchi during movement, thereby enabling preservation of the kimchi in a form existing at the time of packing and delivery of the kimchi in an optimally fermented and ripened state.

In the present invention, a suitable amount of prepared kimchi is put in the body 10 with reference to the scale indicator 12 formed at a side of the body 10, and then the holding unit 20 is placed on the kimchi in the body 10.

Thereafter, in a state where the lower side of the contact pan 21a is brought into tight contact with the kimchi, the locking grooves 22′ formed on the outer side of the support part 22 are aligned with the corresponding locking protrusions 11 formed on the inner wall of the body 10, and the contact part 21a is pushed downwards to fit the locking grooves 22′ of the holding unit 20 onto the corresponding locking protrusions 11 of the body 10 by stages, to the extent that the kimchi is not readily movable.

When the contained kimchi is pressed by the holding unit 20, the holding unit 20 acts as a stone weight discharging the air present in the kimchi to the outside, enabling preservation of the kimchi in a state existing at the time of preparation. In addition, because the kimchi is packed in a storage container in a state where free movement of the kimchi is limited by the holding unit 20, the kimchi is preserved in a form existing at the time of packing even though the storage container is repeatedly tilted to one side during shipment.

In addition to prevention of kimchi movement, even though the kimchi juice collects at a site owing to repeated tilting of the storage container during shipment, the holding unit 20 forces the kimchi juice to readily permeate through the overall kimchi.

That is, when the holding unit 20 acting as a stone weight presses the kimchi, the kimchi juice enters the holding unit 20 through through-holes 21′ of the contact part 21a Thereafter, the kimchi juice gathers inside the support part 22 formed as a single body like a fence around the contact part 21a During shipment, the gathered kimchi juice may freely move inside the holding unit 20, and return through through-holes 21′ of the upper side of the contact part 21a to the kimchi under the holding unit 20. Thereby, the kimchi is not dried, and can be preserved in a form existing at the time of packing and delivered in an optimally fermented and ripened state.

In a manner described above, kimchi is put in the kimchi container so that the kimchi is submerged under the kimchi juice, and the kimchi container is kept at 5-20 degrees Celsius. The resulting kimchi provides better taste than kimchi stored in a conventional container.

Further, tasty kimchi can be made as follows: cabbages are cleaned, divided into parts, and preserved with salt water of 10-13% concentration for 34 hours at 18-22 degrees Celsius; kimchi is prepared by mixing 86 weight parts of salted cabbage (main ingredient) with supplementary ingredients including 3-5 weight parts of anchovy sauce, 24 weight parts of hot pepper powder, 1-3 weight parts of garlic, 1-3 weight parts of sugar, 0.5-1.5 weight parts of spring onion, 0.01-0.02 weight parts of seasoning, and 1-2 weight parts of bay salt; and the prepared kimchi is stored and kept in a kimchi container for fermentation and ripening.

To identify functionalities of a kimchi container having an enhanced fermentation and ripening function according to the present invention, and changes in taste and benefit of the kimchi accommodated in the kimchi container, experiments were performed to check pH values, acidities, CO₂ concentrations, quantities of lactic acid bacteria, contents of free amino acids, contents of gamma-aminobutyric acids (GABA) and contents of glutamine of kimchis ripened in different kimchi containers.

That is, in the experiments, pH values, acidities, CO₂ concentrations, quantities of lactic acid bacteria, contents of free amino acids, contents of GABA and contents of glutamine of kimchis ripened in kimchi containers of the present invention were measured and compared with corresponding values of kimchis ripened in conventional kimchi containers. For kimchi containers of the present invention, a first experimental group was related to the kimchi ripened at 5 degrees Celsius, and a second experimental group was related to the kimchi ripened at 20 degrees Celsius. For conventional kimchi containers, a first control group was related to the kimchi ripened at 5 degrees Celsius, and a second control group was related to the kimchi ripened at 20 degrees Celsius.

### Example 1

### Measurement of pH and Acidity in Kimchi

During fermentation, the pH of kimchi lowers owing to organic acids other than lactic acids produced by lactic acid bacteria. Generally, the pH of kimchi lowers from 5.8 to 3.8 with the progress of fermentation. The acidity of kimchi is not necessarily proportional to the pH because the produced acids differ from each other in solubility according to the type of kimchi, salt concentration, and temperature. The acidity rises from 0.03% to 1.1% with the progress of fermentation.

In Example 1, pH values and acidities were measured for the first and second experimental groups and the first and second control groups with the passage of fermentation time.

The pH of a kimchi was directly measured by inserting an electrode of a pH meter (Istek model 740P) into the juice of the kimchi.

To determine the acidity of a kimchi, a given amount of the kimchi was taken, distilled water of the same amount as that of the taken kimchi was added to the taken kimchi, a given amount of juice was taken, the taken juice was titrated with 0.1N NaOH until the pH of the juice became 8.3, and the amount of 0.1N NaOH consumed to neutralize the juice was converted into the content of lactic acids using the following equation

$$acidity ( \% ) = \frac{\begin{matrix}amount of tirated 0.1 N NaOH \times \\ 0.009 \times Factor \times 100 \times dilution\_factor\end{matrix}}{amount of sample ( ml )}$$

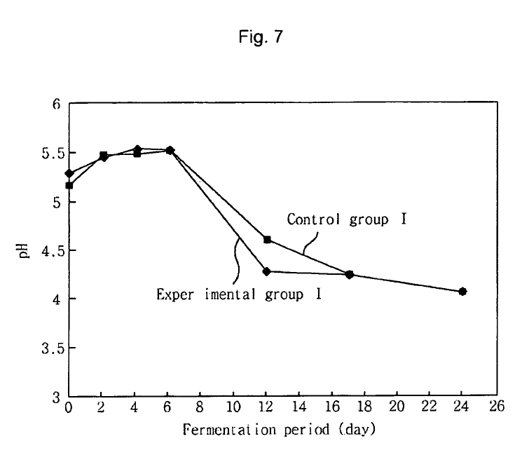

FIGS. 7 to 10 illustrate pH values and acidities that were measured using the above procedures for the first and second experimental groups and the first and second control groups with the passage of fermentation time.

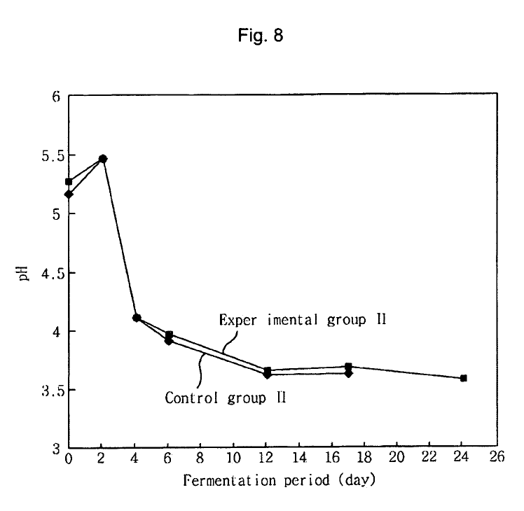

As shown in FIG. 7 (fermentation at 5 degrees Celsius), the pH of the kimchi of the first experimental group rose from 5.2 to 5.5 until 6 days from storage, and lowered to 4.2 until 24 days from storage. The pH of the first control group showed nearly the same pattern as that of the first experimental group. As shown in FIG. 8 (fermentation at 20 degrees Celsius), the pH of the kimchi of the second experimental group rapidly rose from 5.2 to 5.5 until 2 days from storage, and rapidly lowered to 3.7 until 12 days from storage, and remained almost constant until 24 days from storage. The pH of the second control group showed nearly the same pattern as that of the second experimental group.

It is known that kimchi gives the best taste at pH 4.2. pH 4.2 was reached at 12 days from storage for the first experimental group and first control group, and at 4 days from storage for the second experimental group and second control group. As to pH, a storage container was not significantly different from another storage container.

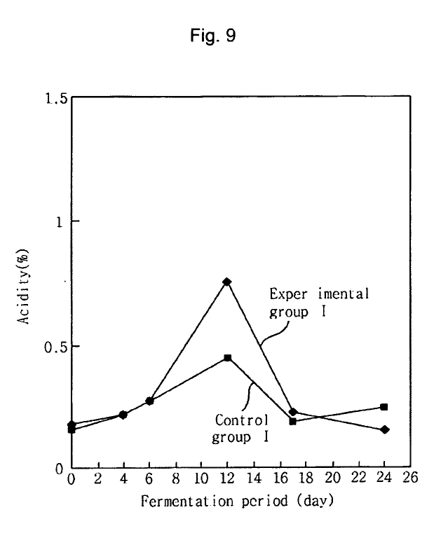

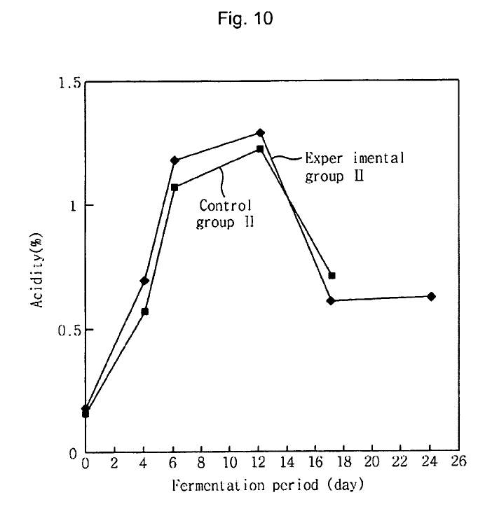

As shown in FIG. 9 (first experimental group and first control group) and in FIG. 10 (second experimental group and second control group), the acidity of the kimchi stored in the container of the present invention was significantly higher than that associated with a conventional container.

### Example 2

### Measurement of CO₂ Concentration in Kimchi

The fermentation pattern of kimchi is closely related with the amount of generated CO₂.

In kimchi, CO₂ is an element for fresh taste, and is an important indicator to fermentation along with the acidity. Generally, in a kimchi container during fermentation, the CO₂ concentration rises continuously and the O₂ concentration lowers at a range of temperatures. The amount of generated CO₂ differs depending upon the type of kimchi, storage temperature, and salt concentration Gaseous CO₂ dissolves in kimchi juice, producing spicy and fresh taste.

In Example 2, CO₂ concentrations were measured for the first and second experimental groups and the first and second control groups with the passage of fermentation time.

To measure the CO₂ concentration of a kimchi 2M Na K tartrate solution and 2M Na citrate solution were mixed together at a ratio of 1:1 to produce a tartrate-citrate solution, which was then neutralized with 1N NaOH until a pale red color appeared. Thereafter, 50 ml of the double-diluted kimchi juice was added to 10 ml of 0.1N NaOH and 5 ml of the tartrate-citrate solution in an Erlenmeyer flask (500 ml), and was then titrated with 0.1N HCl until the pH meter indicated pH 8.3. After titration, the CO₂ concentration was computed using the following equation

$$CO 2 ( mg \text{/} L ) = \frac{( V 1 - V 2 ) \times 1.1 \times 1 \times {10}^{4} \times dilution\_factor}{amount of sample ( ml )}$$

where V1 denotes the volume of 0.1N NaOH (ml) and V2 denotes the volume of 0.1N HCl (ml).

In the case of the kimchi having a low pH, a given amount of the diluted kimchi juice was separately taken, and shaken vigorously or heated at 80 degrees Celsius to completely remove the dissolved CO₂ before titration. The content of free CO₂ was obtained by subtracting a correction value from the titrated value obtained using the above procedure. The corrected value for CO₂ was computed using the above equation.

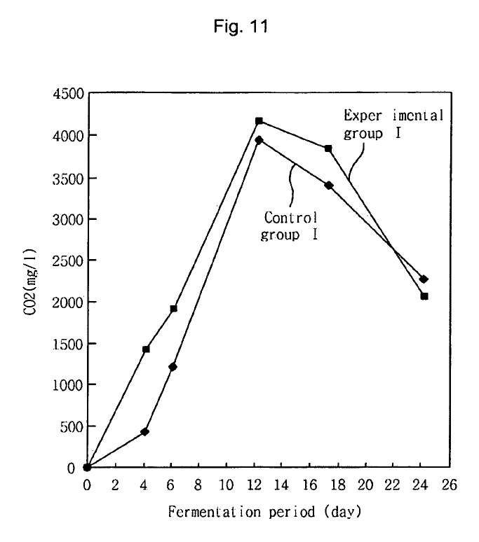

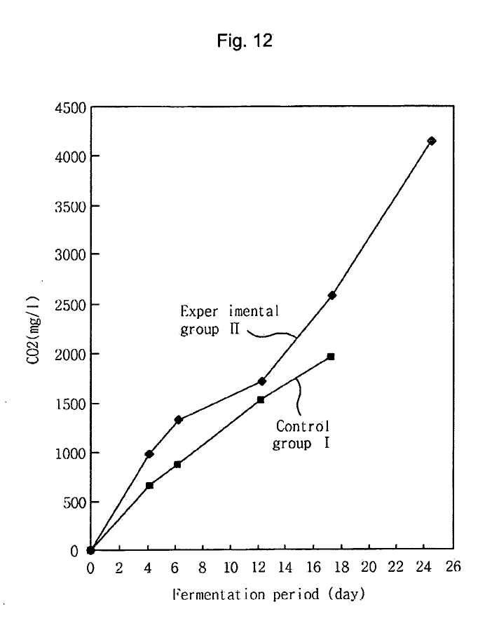

FIGS. 11 and 12 illustrate concentrations of CO₂ dissolved in the kimchi juice, which were measured using the above procedure for the first and second experimental groups and the first and second control groups with the passage of fermentation time.

As shown in FIG. 11 (first experimental group and first control group), the CO₂ concentrations rose continuously until 12 days from storage, and lowered thereafter. The amount of CO₂ in the kimchi juice associated with the first experimental group was greater than that associated with the first control group by about 20%. The CO₂ concentrations reached peak values of 3800-4100 mg/kg at 12 days from storage. This may explain the reason for the fact that a kimchi gives a better taste when the kimchi is kept in a submerged state under the kimchi juice and allowed to undergo fermentation.

As shown in FIG. 12, the CO₂ concentration of the kimchi juice associated with the second experimental group was higher than that associated with the second control group, and was 1400-1700 mg/kg at 12 days from storage and lower than that associated with the first experimental group. This might be explained by the fact that a higher temperature resulted in activated fermentation, leading to acceleration of CO₂ generation and severe swelling of the pack but also to a decrease in CO₂ dissolution in the kimchi juice.

### Example 3

### Counting Lactic Acid Bacteria in Kimchi

The ripening process of a kimchi is a composite fermentation process determined by a plurality of factors such as storage temperature, table salt concentration, and main and supplementary ingredients. Various microbes are involved in the ripening process.

Gram-negative bacteria and endospore-forming Gram-positive bacteria appear at the early stage of fermentation and subsequently die off, and then lactic acid fermentation begins. The kimchi, in a state suitable to eat after progress of fermentation, includes Gram-positive bacteria, Gram-negative bacteria, and Gram-positive bacteria in yeast groups such as Lactobacillus sp., Leuconostoc sp., Pediococcus. sp., Enterococcus sp. and Lactococcus sp. Microorganisms are diverse in distribution and frequency. Representative microorganisms are Leuconostoc mesenteroides, Leuconostoc paramesenteroides, Streptococcus raffinolactis, Lactobacillus plantarum, and Lactobacillus sake. At the late stage of fermentation, fermenting yeast such as Saccharomyces fermentati and Pichia halophilia produces alcohol and flavor compounds.

In Example 3, lactic acid bacteria ware counted for the first and second experimental groups and the first and second control groups with the passage of fermentation time.

The number of lactic acid bacteria in the kimchi was determined using a plate count agar method, where a sample was diluted with a physiological saline solution, cultured in a medium, and counted.

For Leuconostoc sp., 42.5 g of a PES medium supplemented with phenylethyl alcohol agar and sucrose was dissolved in 1 l of distilled water, and sterilized at 121 degrees Celsius for 15 minutes. Thereafter, a sample was inoculated, plate-cultured at 20 degrees Celsius for 5 days, and then counted. The PES medium was composed of 15 g of pancreatic digest casein, 5 g of papaic soybean meal, 15 g of NaC, 2.5 g of phenylethyl alcohol, and 15 g of agar.

For Lactobacillus sp., 55 g of a Lactobacillus MRS Broth agar medium was dissolved in 1 l of distilled water, and sterilized at 121 degrees Celsius for 15 minutes. Thereafter, a sample was inoculated, and cultured at 37 degrees Celsius for 3-4 days. Appeared colonies were counted and the number of colonies was multiplied by the dilution factor. The Lactobacillus MRS Broth agar medium was composed of 10 g of bacto proteose peptone, 5 g of bacto beef extract, 5 g of bacto yeast extract, 20 g of bacto dextrose, 1 g of Tween 80, 2 g of ammonium citrate, 5 g of sodium citrate, 0.05 g of magnesium sulfate, 0.05 g of manganese sulfate, 2 g of dipotassium phosphate, and 15 g of agar.

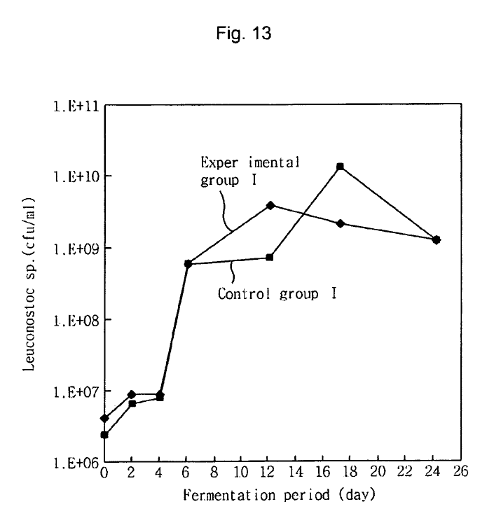

FIGS. 13 to 16 illustrate counts of lactic acid bacteria (Leuconostoc sp. and Lactobacillus sp.), which were determined using the above procedure for the first and second experimental groups and the first and second control groups with the passage of fermentation time.

As shown in FIG. 13 (Leuconostoc sp.), the number of bacteria associated with the first experimental group rapidly increased from 6 days after the start of fermentation, then at 12 days reached a peak of 1.1×10¹⁰/ml, which was greater than that of 6×10⁹/ml associated with the first control group, and became less than that associated with the first control group after 12 days.

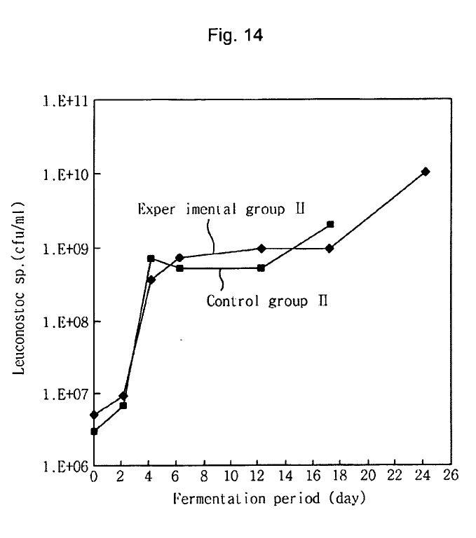

As shown in FIG. 14 (Leuconostoc sp.), the number of bacteria associated with the second experimental group reached a peak at 4 days from the start of fermentation, remained without significant change until 16 days, and was not much different from that associated with the second control group.

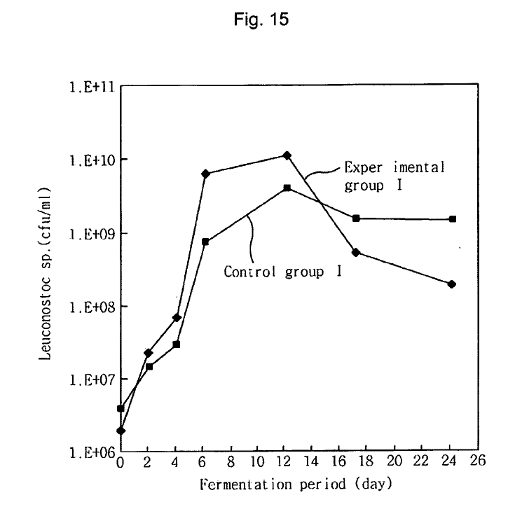

As shown in FIG. 15 (Lactobacillus sp.), the number of bacteria associated with the first experimental group reached a peak of 5.5×10⁹/ml at 12 days from the start of fermentation, which was greater than that associated with the first control group, and decreased thereafter. The number of bacteria associated with the first control group reached a peak at 12 days.

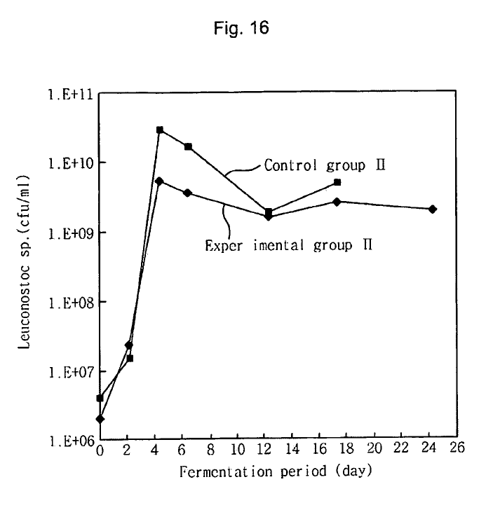

As shown in FIG. 16 (Lactobacillus sp.), the number of bacteria associated with the second experimental group rapidly increased from 2 days after the start of fermentation and at 4 days reached a peak of 7.2×10⁹/m, which was less than that of 6×10⁹/ml associated with the second control group.

As described above, the kimchi container of the present invention demonstrated its effectiveness at 5 degrees Celsius because the number of lactic acid bacteria associated with the first experimental group was greater than that associated with the first control group. However, the kimchi container failed to demonstrate its effectiveness at 20 degrees Celsius. During fermentation at 5 degrees Celsius: the kimchi packed in a conventional container (first control group) was exposed in part to the air, and oxygen retarded proliferation of anaerobic bacteria of Lactobacillus sp. and Leuconostoc sp.; and the kimchi packed in the kimchi container (first experimental group) was submerged under the kimchi juice, facilitating proliferation of bacteria of Lactobacillus sp. and Leuconostoc sp.

### Example 4

### Content of Free Amino Acids in Kimchi

Free amino acids are produced by kimchi ingredients such as salted fish, and lactic acid bacteria, and are very important for nutrition and taste.

In Example 4, the content of free amino acids was measured for the first and second experimental groups with the passage of fermentation time.

To measure the content of free amino acids in a kimchi, 5 g of the kimchi was 10-fold diluted with distilled water, boiled for 15 minutes, filtrated, and 50 ml was taken and measured for the sample. The sample was then derivatized, and analyzed through gas chromatography-mass spectrometry (GC-MS), and the results were multiplied by the dilution factor.

Table 1 and Table 2 show the content of free amino acids measured for the first and second experimental groups with the passage of fermentation time.

Table 1 shows the content of free ammo acids measured for the first experimental group, fermented at 5 degrees Celsius.

TABLE 1

| | Just after | 10 days | 20 days |
|---|---|---|---|
| | preparation | fermentation | fermentation |
| Amino acid | (ppm) | (ppm) | (ppm) |
| Alanine | 368 | 442 | 392 |
| Glycine | 210 | 230 | 196 |
| Alpha-aminobutyric acid | 96 | 74 | 84 |
| Valine | 310 | 326 | 312 |
| Leucine | 368 | 360 | 332 |
| Isoleucine | 210 | 220 | 224 |
| Threonine | 150 | 190 | 162 |
| Serine | 196 | 194 | 192 |
| Proline | 474 | 254 | 260 |
| Asparagine | 546 | 164 | 144 |
| Aspartic acid | 422 | 614 | 690 |
| Methionine | 148 | 138 | 130 |
| Glutamic acid | 1826 | 1144 | 1322 |
| Phenylalanine | 250 | 226 | 208 |
| Ornithine | 192 | 172 | 198 |
| Lysine | 1110 | 1164 | 1172 |
| Histidine | 206 | 196 | 192 |
| Tyrosine | 86 | 134 | 88 |
| Tryptophan | 46 | 8 | 30 |

Table 2 shows the content of free amino acids measured for the second experimental group, fermented at 20 degrees Celsius.

TABLE 2

| | Just after | 10 days | 20 days |
|---|---|---|---|
| | preparation | fermentation | fermentation |
| Amino acid | (ppm) | (ppm) | (ppm) |
| Alanine | 368 | 444 | 410 |
| Glycine | 210 | 238 | 218 |
| Alpha-aminobutyric acid | 96 | 74 | 68 |
| Valine | 310 | 350 | 312 |
| Leucine | 368 | 414 | 340 |
| Isoleucine | 210 | 250 | 204 |
| Threonine | 150 | 178 | 160 |
| Serine | 196 | 190 | 182 |
| Proline | 474 | 276 | 264 |
| Asparagine | 546 | 236 | 248 |
| Aspartic acid | 422 | 614 | 584 |
| Methionine | 148 | 168 | 146 |
| Glutamic acid | 1826 | 1396 | 1550 |
| Phenylalanine | 250 | 266 | 206 |
| Ornithine | 192 | 44 | 64 |
| Lysine | 1110 | 1166 | 932 |
| Histidine | 206 | 236 | 136 |
| Tyrosine | 86 | 8 | 6 |
| Tryptophan | 46 | 32 | 50 |

As shown in Table 1 and Table 2, the content of free amino acids associated with the first experimental group was not very different from that associated with the second experimental group, and differences due to fermentation temperatures were not demonstrated. With the progress of fermentation, proline, asparagine and tryptophan decreased, and alanine and aspartic acid increased. Glutamic acid, lysine, asparagine, proline and aspartic acid were highest in content in that order.

It was thought that a high content of Glutamic acid was caused by the seasoning and high contents of some amino acids including lysine were caused by ingredients such as salted fish.

### Example 5

### Content of GABA and Glutamine in Kimchi

Gamma-aminobutyric acid (GABA) is known as a functional substance, and was found by Roberts in 1950 at the cerebellum of a mammal as an inhibitory neurotransmitter. A low GABA content may result in alcoholic brain disease. Recently, GABA has been recognized as an important functional substance, which contributes to removal of insomnia, prevention of paralytic dementia, removal of obesity, activation of liver function, promotion of alcohol metabolism, and reduction of blood pressure.

Glutamine is a non-essential amino acid, and is not water-soluble. Because an aqueous solution of glutamine is unstable, it is not easy to use liquefied glutamine. Exhaustion of glutamine is fatal to the human body, and glutamine is regarded as a conditional essential amino acid. Glutamine is used as the sole energy source for cells of the small intestine, and widely used to improve immunity, prevent muscle destruction due to exercise, and heighten muscular strength.

In Example 5, the content of GABA and glutamine was measured for the first and second experimental groups with the passage of fermentation time, and the results are shown in Table 3 and Table 4.

Table 3 shows the content of GABA measured for the first and second experimental groups with the passage of fermentation time.

TABLE 3

| | Just after | | 20 days |
|---|---|---|---|
| | preparation | 10 days | fermentation |
| Group | (ppm) | fermentation (ppm) | (ppm) |
| experimental group 1 | 226 | 1554 | 1396 |
| (5 degrees Celsius) | | | |
| experimental group 2 | 226 | 1328 | 972 |
| (20 degrees Celsius) | | | |

Table 4 shows the content of glutamine measured for the first and second experimental groups with the passage of fermentation time.

TABLE 4

| | Just after | | 20 days |
|---|---|---|---|
| | preparation | 10 days | fermentation |
| Group | (ppm) | fermentation (ppm) | (ppm) |
| Experimental group 1 | 356 | 1154 | 1060 |
| (5 degrees Celsius) | | | |
| Experimental group 2 | 356 | 726 | 1216 |
| (20 degrees Celsius) | | | |

As shown in Table 3, in the kimchi fermented at 5 degrees Celsius, the content of GABA rapidly increased from 226 ppm to 1554 ppm at 10 days from the start of fermentation, and became 1396 ppm at 20 days. The content of GABA in the kimchi fermented at 20 degrees Celsius showed a trend similar to the case of the kimchi fermented at 5 degrees Celsius. As shown in Table 4, in the kimchi fermented at 5 degrees Celsius, the content of glutamine increased from 356 ppm to 1154 ppm at 10 days from the start of fermentation, and became 1060 ppm at 20 days. The content of glutamine in the kimchi fermented at 20 degrees Celsius showed a trend similar to the case of the kimchi fermented at 5 degrees Celsius.

Consequently, the kimchi of the present invention can be regarded as a functional kimchi having large amounts of functional substances like GABA and glutamine, which are considered to be produced by various lactic acid bacteria present in the kimchi.

What is claimed is:

1. A kimchi container with an improved fermentation and ripening function, comprising:
a body to accommodate kimchi, including locking protrusions normally projected from four sides of an inner wall of the body and an opened side to be vacuum-sealed with a sheet after accommodation of the kimchi; and
a holding unit including:
a contact part having a cross-sectional area corresponding to that of the inner bottom of the body, and a plurality of through-holes formed in the circumference and at a central region of the upper side thereof, and
a plurality of locking grooves, to be fitted onto corresponding locking protrusions of the body, formed at an outer wall upwardly extended from and integrally formed with the rim of the contact part
wherein the lower side of the contact part contacts with the kimchi accommodated in the body by fitting the locking grooves of the holding unit onto the corresponding locking protrusions of the body by stages, so that, when the kimchi container is tilted to one side during movement, the kimchi juice enters the holding unit through the through-holes of the contact part, and circulates freely within the holding unit, and returns to the kimchi through the through-holes.

2. The kimchi container according to claim 1, wherein the holding unit comprises a dome-shaped contact part suitable for accommodating whole-cabbage kimchi.

3. The kimchi container according to claim 1, wherein the holding unit comprises a contact part having a hemispheric pressing structure at a central part of the lower side thereof to prevent the kimchi from freely moving during shipment.

4. The kimchi container according to claim 1, wherein the holding unit further comprises an outwardly inclined support part so that locking grooves of the support part are elastically coupled to corresponding locking protrusions of the body.

5. The kimchi container according to claim 1, wherein the through-holes in the outer circumference of the contact part are formed more densely than those of the through-holes formed at the central region so that the kimchi juice readily flows through the holding unit.

6. The kimchi container according to claim 1, wherein the body has a scale indicator formed at a side thereof to enable a user to easily check the amount of kimchi accommodated in the body.

7. A kimchi ripening method using a kimchi container as set forth in claim 1.

8. The kimchi ripening method according to claim 7, wherein kimchi accommodated in the kimchi container is kept so as to be constantly submerged under kimchi juice during a ripening period.

9. The kimchi ripening method according to claim 8, wherein the kimchi is kept at 5-20 degrees Celsius during the ripening period.

10. Kimchi made using a kimchi container as set force in claim 1.

11. The kimchi according to claim 10, wherein the kimchi is prepared by mixing 86 weight parts of salted cabbage (main ingredient) with supplementary ingredients including 3-5 weight parts of anchovy sauce, 24 weight parts of hot pepper powder, 1-3 weight parts of garlic, 1-3 weight parts of sugar, 0.5-1.5 weight parts of spring onion, 0.01-0.02 weight parts of seasoning, and 1-2 weight parts of bay salt.

12. The kimchi according to claim 10, wherein the kimchi has a pH of 3.5-5.0, an acidity of 0.3-0.9%, a CO₂ concentration of 1400-4100 mg/kg, 4.5×10⁹-7.2×10⁹ Lactobacillus sp. bacteria (per ml), 5.0×10⁹-1.1×10¹⁰ Leuconostoc sp. bacteria (per ml), a GABA content of 900-1600 ppm, and a glutamine content of 700-1300 ppm.
